(19) United States
(12) Patent Application Publication
(10) Pub. No.: US 2012/0003560 A1
(43) Pub. Date: Jan. 5, 2012

(54) FUEL CELL FOR MOISTURE MANAGEMENT AT GAS INLETS

(76) Inventors: Jeremy P. Meyers, Austin, TX (US); Michael L. Perry, Glastonbury, CT (US); Carl A. Reiser, Stonington, CT (US); Ned E. Cipollini, Enfield, CT (US); Wayde R. Schmidt, Pomfret Center, CT (US); Gopal R. Krishnan, Wethersfield, CT (US); John A. Trela, Seattle, WA (US); Robert M. Darling, South Windsor, CT (US)

(21) Appl. No.: 13/256,290

(22) PCT Filed: Mar. 18, 2009
(86) PCT No.: PCT/US09/37500

§ 371 Date: Sep. 13, 2011

(51) Int. Cl. H01M 8/04; H01M 2/08

(52) U.S. Cl. 429/450; 429/514; 429/509; 429/508

(57) ABSTRACT

A fuel cell includes an electrode assembly having an electrolyte between a cathode catalyst and an anode catalyst, and a flow field plate having a channel for delivering a reactant gas to the electrode assembly. The flow field plate includes a channel having a channel inlet. A porous diffusion layer is located between the electrode assembly and the flow field plate. The porous diffusion layer includes a first region near the channel inlet and a second region downstream from the first region relative to the channel inlet. The first region includes a filler material that partially blocks pores of the first region such that the first region has a first porosity and the second region has a second porosity that is greater than the first porosity.

### BACKGROUND

This disclosure relates to moisture management in a fuel cell. Fuel cells typically include an anode catalyst, a cathode catalyst, and an electrolyte (e.g., polymer electrolyte membrane, “PEM”) between the anode and cathode catalysts for generating an electric current in a known electrochemical reaction between reactant gases, such as fuel and oxidant. The fuel cell may include flow field plates with channels for directing the reactant gases to the respective catalysts. Conventional fuel cells utilize inlets and exits to deliver the reactant gases to the channels and discharge exhaust gas from the channels. Typically, a porous gas diffusion layer between the flow field plate and a given catalyst functions to distribute the reactant gas to the catalyst.

One challenge associated with a conventional fuel cell is that the oxidant (e.g., air) delivered to the inlets is relatively dry and draws moisture out of the PEM in the area of the inlets. The ionic conductivity of the PEM will diminish if the PEM dries out. Additionally, drying may accelerate degradation of the PEM and diminish the useful life.

Another challenge associated with a conventional fuel cell is that the temperature of the incoming air and/or fuel may be higher than the temperature of the fuel cell at the inlet. As a result, the reactant gas may cool at the inlet and any moisture in the air may condense and accumulate as droplets on portions of the inlet, such as a seal. The droplets may block, in whole or in part, flow of the gas into a given channel and cause non-uniform current distribution. At relatively higher current densities the velocity of the gas flow may dislodge the droplets. At lower current densities and corresponding lower flow velocity, the droplets may not dislodge and could cause uneven flow distribution among the channels and inlets.

### SUMMARY

An example fuel cell includes an electrode assembly having an electrolyte between a cathode catalyst and an anode catalyst, and a flow field plate having a channel for delivering a reactant gas to the electrode assembly. The flow field plate includes a channel having a channel inlet. A porous diffusion layer is located between the electrode assembly and the flow field plate. The porous diffusion layer includes a first region near the channel inlet and a second region downstream from the first region relative to the channel inlet. The first region includes a filler material that partially blocks pores of the first region such that the first region has a first porosity and the second region has a second porosity that is greater than the first porosity.

An example method of moisture management in the fuel cell includes limiting moisture transport through the pores of a first region relative to moisture transport through the pores of the second region with the filler material that partially blocks the pores in the first region such that the first region has the first porosity and the second region has the second porosity that is greater than the first porosity.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 is an example fuel cell.

FIG. 2 is a sectional view of the fuel cell of FIG. 1.

FIG. 3 is a portion of another example fuel cell.

FIG. 4 is a portion of another example fuel cell.

FIG. 5 is an example of a seal in a fuel cell.

### DETAILED DESCRIPTION

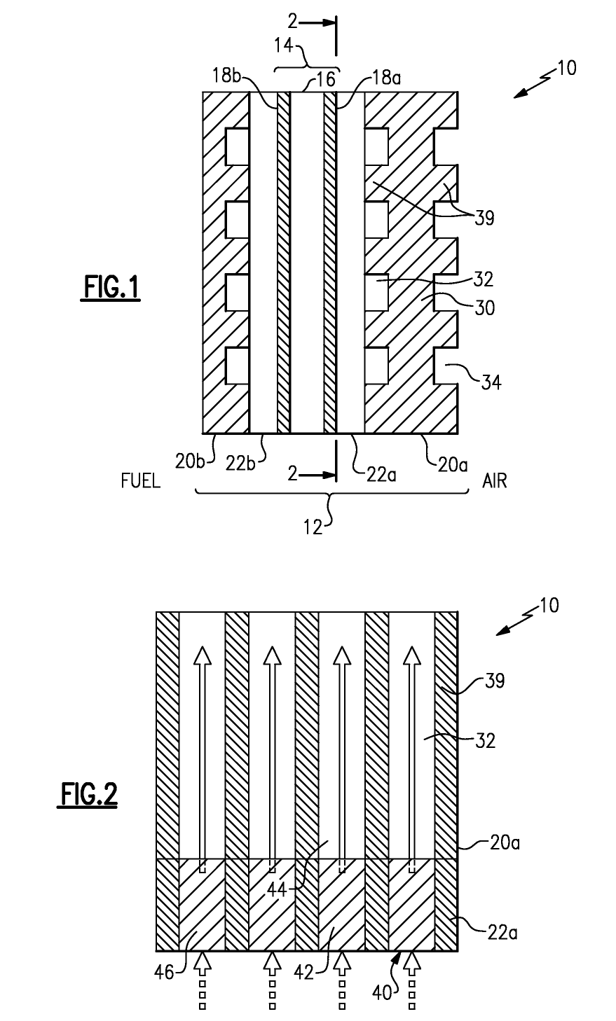

FIG. 1 illustrates selected portions of an example fuel cell 10 for generating an electric current in a known electrochemical reaction between reactant gases, for example. It is to be understood that the disclosed arrangement of the fuel cell 10 is only an example and that the concepts of this disclosure may be applied to other fuel cell arrangements.

The example fuel cell 10 includes one or more fuel cell units 12 that may be stacked in a known manner to provide the assembly of the fuel cell 10. Each of the fuel cell units 12 includes an electrode assembly 14 having an electrolyte 16, such as a polymer electrolyte membrane, between a cathode catalyst 18a and an anode catalyst 18b. The electrode assembly 14 is located between flow field plates 20a and 20b for delivering reactant gases (e.g., air and hydrogen) to the electrode assembly 14. The flow field plate 20a may be regarded as an air plate for delivering air to the cathode catalyst 18a and the flow field plate 20b may be regarded as a fuel plate for delivering hydrogen to the anode catalyst 18b.

The fuel cell unit 12 includes porous diffusion layers 22a and 22b between the electrode assembly 14 and respective flow field plates 20a and 20b. For instance, the porous diffusion layers 22a and 22b distribute reactant gases from the flow field plates 20a and 20b to the respective cathode catalyst 18a and anode catalyst 18b.

The flow field plates 20a and 20b may be substantially similar. Thus, the disclosed examples made with reference to the flow field plate 20a may also apply to the flow field plate 20b. In other examples, the flow field plate 20b may be different or include some of the same features as the flow field plate 20a.

In the illustrated example, the flow field plate 20a includes a plate body 30 having reactant gas channels 32 and coolant channels 34 that extend between ribs 39. One or both of the flow field plates 20a and 20b may include the coolant channels 34. The reactant gas channels 32 are located on a side of the flow field plate 20a that faces in the direction of the electrode assembly 14, and the coolant channels 34 are located on the opposite side of the flow field plate 20a. The channels 32 and 34 may be linear; however, given this description, one of ordinary skill in the art will recognize suitable channel configurations to meet their particular needs. Alternatively, plate 20b may contain coolant channels instead of plate 20a.

The bipolar flow field plates 20a and 20b in polymer-electrolyte fuel cells may be solid or microporous. Microporous plates are often called water transfer plates and they facilitate management of water. This disclosure deals with water transport plates.

FIG. 2 is a sectional view of the fuel cell 10 shown in FIG. 1. Each of the reactant gas channels 32 includes an inlet 40 for receiving a reactant gas from a supply source, such as a manifold (not shown) in the flow field plate 20a or source that is external to the fuel cell 10.

The porous diffusion layer 22a includes a first region 42 near the inlet 40 and a second region 44 downstream from the first region 42 relative to the inlet 40. For example, the porous diffusion layer 22a may be a conductive fibrous material, such as a carbon fiber cloth, having pores that permit gas permeation between the electrode assembly 14 and the reactant gas channels 32. In this example, the pores in the first region 42 include a filler material 46 partially blocking the pores such that the first region 42 has a first porosity and the second region 44 has a second porosity that is greater than the first porosity. The “porosity” refers to the volume of open pore space in the given region.

In the illustrated example, the first regions 42 extend primarily over the ends of the reactant gas channels 32 and not over the ribs 39, although there may be some overlap with the ribs 39. For instance, a majority of the area of the first region 42 spans over the reactant gas channel 32 relative to any area of the first region 42 that spans over the ribs 39. In other examples, the first region 42 may extend across the ribs 39 and reactant gas channels 32, to simplify the design.

The difference in the porosities between the first region 42 and the second region 44 facilitates hydration of the electrolyte 16 near each inlet 40. For instance, the reactant gas (air in this example) entering each inlet 40 is relatively dry and creates a partial pressure differential of water that tends to drive water vapor from the electrolyte 16 toward the reactant gas in the channels 32. However, the relatively lower porosity of the first region 42 compared to the second region 44 limits moisture transport through the first region 42 to facilitate keeping the electrolyte 16 in a hydrated state near the inlets 40. The first region 42 may consequently also inhibit transport of the air to the electrode assembly 14. However, since the fuel cell 10 has not yet consumed the oxygen from the air, the oxygen concentration is relatively high near the inlets 40 and may provide an adequate current density even at lower flows to the cathode catalyst 18a. In some examples, the reduced permeation of oxygen to the electrode assembly 14 may even provide a more uniform current density across the entire fuel cell 10.

The filler material 46 in the first region 42 may be a polymer that is impregnated into the pores of the porous diffusion layer 22a in a known manner. For example, the polymer may be impregnated using melt impregnation. The filler material 46 may be incorporated into the porous diffusion layer 22a during forming of a perimeter seal for the electrode assembly 14 or during stacking. The polymer may be a fluoropolymer, such as polytetrafluoroethylene, polyvinylidinefluoride, perfluorosulfonic acid, or combinations thereof. In some examples, the selected polymer is generally resistant to oxidizing and dissolving in water to withstand typical fuel cell conditions.

The amount of filler material 46 used in the first region 42 may vary, depending upon the desired level of porosity. In some examples, the entire porous diffusion layer 22a may initially have a porosity of about 70-80% before assembly into the fuel cell 10. In general, the porosity of the second region 44 may be greater than about 50% after compression in the fuel cell 10 and the porosity of the first region 42 may be 25-50% after compression in the fuel cell 10. In a further example, the porosity of the first region 42 may be about 40%. The porosity may be selected based on the operating conditions of the particular fuel cell 10. For instance, if the porosity of the first region 42 is too low, not enough air will diffuse to the electrode assembly 14 to provide a desired current. On the other hand, if the porosity of the first region 42 is too high the first region 42 may have limited effectiveness for maintaining hydration of the electrolyte 16. The term “about” as used in this description relative to given values refers to possible variation in the given value, such as normally accepted variations or tolerances.

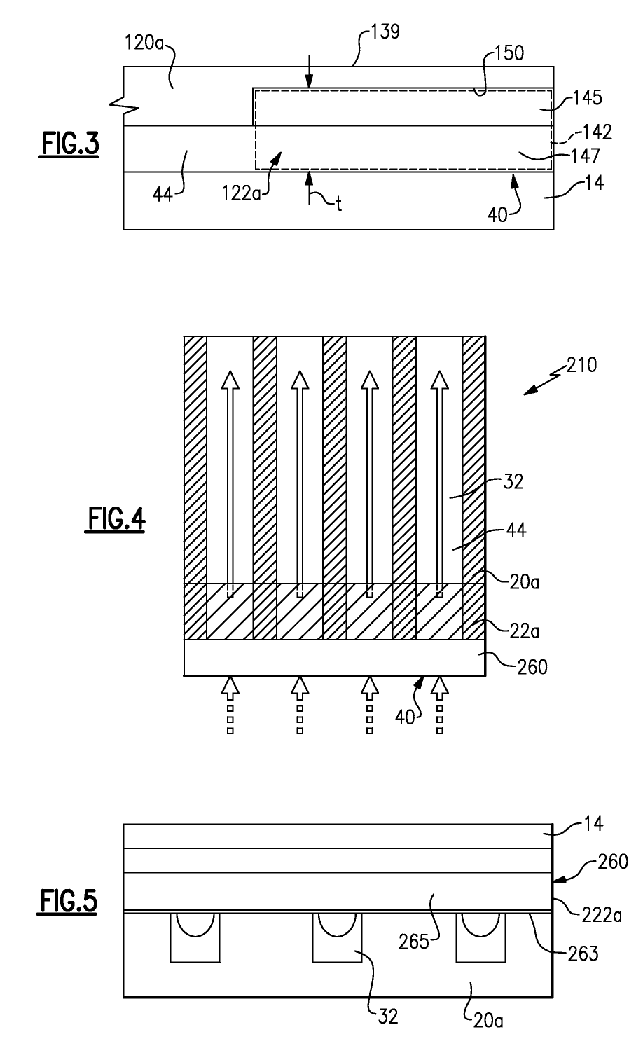

FIG. 3 illustrates another example of a flow field plate 120a that may be used in place of the flow field plate 20a of the previous examples. In this example, the ribs 139 of the flow field plate 120a include a recess 150. The first region 142 extends at least partially into the recess 150 such that a thickness of the porous diffusion layer 122a near the inlet 40 is thicker than the second region 44. In this example, the first region 142 includes a first layer 145 within the recess 150 and a second layer 147 that is generally coplanar with the second region 44. For instance, the second layer 147 may be a continuous extension of the second region 44, and the first layer 145 may be a separate and distinct piece of porous diffusion material, such as carbon fiber paper. The first layer 145 has the lower, first porosity that limits moisture transport as explained for the previous examples. The second layer 147 has a higher, second porosity that is approximately equivalent to the porosity of the second region 44. Thus, the first region 142 includes a porosity gradient between the flow field plate 120a and the electrode assembly 14 near the inlet 40.

The first region 42, 142 may be “wickable” to actively transport liquid water from the reactant gas or flow field plate 20a, 120a to the electrolyte 16. For instance, the pores of the first region 42, 142 may be capillary-sized to promote capillary forces that draw liquid water through the pores to the electrolyte 16. Drawing liquid water may provide better hydration of the electrolyte 16 rather than relying on the more complex and condition-dependent mechanism of water evaporation, vapor transport through the porous diffusion layer 22a, and condensation at the electrolyte 16. In one example, the pores have an average size of about 0.5-1 micrometer. The wicking may also enable the fuel cell 10 to use supersaturated reactant gases, such as reformulate fuel from high temperature reforming processes, which might otherwise cause condensation and water droplet formation that blocks channel inlets.

Additionally, the fuel cell 10 may control the reactant gas and coolant pressures such that the coolant pressure is greater than the reactant gas pressure at the inlets 40 to force water into the pores of the first region 42, 142. As an example, U.S. Pat. No. 7,438,986 discloses how to control a pressure profile.

The filler material 46 incorporated into the first region 42, 142 may be hydrophilic to facilitate attraction of liquid water. For instance, the filler material may include a hydrophilic polymer and/or hydrophilic filler particles. In one example, the composition of the filler material may include about 85-90 wt % of filler particles, such as carbon particles (e.g., carbon black), and a remainder of polymer as a binder of the particles.

The flow field plate 20a, 120a includes pores for transporting water. Such plates may be known as water transport plates. In this example, the pores of the first region 42, 142 near the inlet 40 are smaller in average size than the pores of the flow field plate 20a, 120a. Using smaller pores in the first region 42, 142 than in the flow field plate 20a, 120a provides capillary forces in the first region 42, 142 that are greater than capillary forces in the flow field plate 20a, 120a to thereby draw liquid water from the flow field plate 20a, 120a toward the electrode assembly 14 near the inlets 40. The hydrophilicity of the first region 42, 142 may also facilitate removal of any water droplets that might form from condensation near the inlets 40.

In some examples, the filler material 46 incorporated into the first region 42, 142 may be used to increase the rigidity of the first region 42, 142 compared to the second region 44. For example, the first region 42, 142 may have a first rigidity and the second region 44 may have a second rigidity that is less than the first rigidity. The filler material 46 may include a polymer as disclosed in previous examples and filler/reinforcement particles, such as carbon black. In one example, the filler material 46 may have a composition including greater than 50 wt % of the polymer and a remainder of the filler/reinforcement particles to achieve a desired rigidity.

The increased rigidity of the first region 42, 142 facilitates reduction of deformation of the porous diffusion layer 22a into the reactant gas channels 32 when the fuel cell 10 is compressed for assembly. Thus, the increased rigidity of the first region 42 facilitates maintaining the dimensions of the inlets 40.

In some examples, the first region 42, 142 may be a separate piece from the second region 44. For instance, the second region 44 may be formed of carbon fiber paper and the first region 42, 142 may be formed as an extension of a porous portion of the flow field plate 20a, 120a.

In some examples, the filler material in the first region 42, 142 may be liquid water. For instance, the pores of the first region 42, 142 may be capillary-sized to create capillary forces that draw water from the coolant channels 34 or pores of the flow field plate 20a, 120a. In this regard, the first region 42, 142 may thereby also function as a seal to limit escape of the reactant gas to the surrounding environment.

FIG. 4 is a portion of another example fuel cell 210 that is similar to the previous example fuel cell 10 but includes a seal 260 that extends partially or completely around the perimeter of the flow field plate 20a. In this example, the porous diffusion layer 22a may be essentially completely filled with a seal material to close the pores and seal the fuel cell 210 from the surrounding environment. The seal 260 may have pores, but the pores do not form a path to the surrounding environment.

The seal material may be either hydrophilic or hydrophobic to facilitate reducing water droplet accumulation at the inlets 40. For instance, if the seal 260 is hydrophilic, any water that condenses near the seal 260 may be wicked into pores between the fibers of the porous diffusion layer 22a rather than accumulating as a water droplet. If the seal 260 is hydrophobic, such as having a water contact angle that is greater than 150°, any droplets that accumulate will weakly adhere to the seal 260 such that the droplets are easily removed with a relatively low velocity flow of reactant gas.

Hydrophilic seal materials may include acrylic, thiol, silicone, or combinations thereof. Alternatively, a polymer may be mixed with a relatively hydrophilic filler particle to achieve hydrophilicity. For example, the seal material may include a hydrophilic powder, such as an oxide or hydroxide of tin, titanium, tantalum, niobium, zirconium, hafnium, aluminum, silicon, or carbon. The powder may be pre-mixed with the polymer, or pressed into the seal 260 after polymer impregnation. In other examples, the hydrophilic powder may be mixed in a slurry with a liquid carrier solvent, impregnated and immobilized into the seal 260 to achieve hydrophilicity.

Hydrophobic seal material may include polypropylene, fluorosilicone, polyvinylidinefluoride, polytetrafluoroethylene, polydimethylsiloxane, polyphenylene sulfide, or combinations thereof. Alternatively, as illustrated in FIG. 5, the seal 260 may include a coating 263 of a hydrophobic material on a seal substrate material 265 that is less hydrophobic.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A fuel cell comprising:
an electrode assembly including an electrolyte between a cathode catalyst and an anode catalyst;
a flow field plate having a channel for delivering a reactant gas to the electrode assembly, the channel having a channel inlet; and
a porous diffusion layer between the electrode assembly and the flow field plate, the porous diffusion layer including a first region near the channel inlet and a second region downstream from the first region relative to the channel inlet, the first region including a filler material that partially blocks pores of the first region such that the first region has a first porosity and the second region has a second porosity that is greater than the first porosity.

2. The fuel cell as recited in claim 1, wherein the filler material includes a polymer.

3. The fuel cell as recited in claim 2, wherein the filler material includes carbon particles mixed with the polymer.

4. The fuel cell as recited in claim 3, wherein the filler material includes less than 50 wt % of the carbon particles.

5. The fuel cell as recited in claim 3, wherein the filler material includes about 80-90 wt % of the carbon particles.

6. The fuel cell as recited in claim 1, wherein the filler material includes a fluoropolymer.

7. The fuel cell as recited in claim 6, wherein the fluoropolymer is selected from a group consisting of polytetrafluoroethylene, polyvinylidinefluoride, perfluorosulfonic acid, and combinations thereof.

8. The fuel cell as recited in claim 1, wherein the first porosity is about 25-50% and the second porosity is greater than 50%.

9. The fuel cell as recited in claim 8, wherein the first porosity is about 40%.

10. The fuel cell as recited in claim 1, wherein the pores of the first region are capillary-sized to promote capillary forces that draw liquid water therethrough.

11. The fuel cell as recited in claim 1, wherein the flow field plate is porous and includes plate pores having a larger average size than the pores in the first region.

12. The fuel cell as recited in claim 1, wherein the first region includes a porosity gradient in a thickness direction between the flow field plate and the electrode assembly.

13. The fuel cell as recited in claim 1, wherein the first region includes a first rigidity and the second region includes a second rigidity that is less than the first rigidity.

14. The fuel cell as recited in claim 1, wherein the filler material includes liquid water.

15. The fuel cell as recited in claim 1, further comprising a seal including a seal material impregnating at least a portion of a perimeter of the porous diffusion layer, the seal material including a polymer selected from acrylic, thiol, silicone, and combinations thereof.

16. The fuel cell as recited in claim 1, further comprising a seal including a seal material impregnating at least a portion of a perimeter of the porous diffusion layer, the seal material including a hydrophilic powder selected from a group consisting of oxides or hydroxides of tin, titanium, tantalum, niobium, zirconium, hafnium, aluminum, silicon, carbon, and combinations thereof.

17. The fuel cell as recited in claim 16, wherein the hydrophilic powder is in a slurry with a liquid carrier solvent.

18. The fuel cell as recited in claim 1, further comprising a seal including a seal material impregnating at least a portion of a perimeter of the porous diffusion layer, wherein the seal material is hydrophobic and has a contact angle with water that is greater than 150°.

19. The fuel cell as recited in claim 18, wherein the seal material is selected from a group consisting of polypropylene, fluorosilicone, polyvinylidinefluoride, polytetrafluoroethylene, polydimethylsiloxane, polyphenylene sulfide, and combinations thereof.

20. The fuel cell as recited in claim 18, wherein the seal comprises a hydrophobic coating, relative to a less hydrophobic substrate seal material of the seal.

21. The fuel cell as recited in claim 1, wherein the channel extends between spaced-apart ribs of the flow field plate, and a majority of the area of the first region spans over the channel relative to any area of the first region that spans over the ribs.

22. A method of moisture management in a fuel cell that includes an electrode assembly having an electrolyte between a cathode catalyst and an anode catalyst, a flow field plate having a channel for delivering a reactant gas to the electrode assembly, the channel having a channel inlet, and a porous diffusion layer between the electrode assembly and the flow field plate, the porous diffusion layer including a first region near the channel inlet and a second region downstream from the first region relative to the channel inlet, the method comprising:
limiting moisture transport through pores of the first region relative to moisture transport through pores of the second region with a filler material that partially blocks the pores in the first region such that the first region has a first porosity and the second region has a second porosity that is greater than the first porosity.
